(19) United States
(12) Patent Application Publication
(10) Pub. No.: US 2019/0338103 A1
(43) Pub. Date: Nov. 7, 2019

(54) LOW VOLATILE, EPOXIDIZED PLASTICIZER COMPOSITION WITH LOW LEVELS OF ORGANIC VOLATILES

(71) Applicant: Arkemea Inc., King of Prussia, PA (US)

(72) Inventors: Mohammad R. KAZEMIZADEH, Blooming Prairie, MN (US); David E. MAIXNER, Blooming Prairie, MN (US); Cecile N. BONNET, Philadelphia, PA (US)

(21) Appl. No.: 16/465,162

(22) PCT Filed: Dec. 7, 2017
(86) PCT No.: PCT/US2017/065068

§ 371 Date: May 30, 2019

Related U.S. Application Data
(60) Provisional application No. 62/431,507, filed on Dec. 8, 2016.

(51) Int. Cl. C08K 5/1515; C08J 3/18

(52) U.S. Cl. CPC C08K 5/1515; C08J 2327/06; C08J 3/18

(57) ABSTRACT

There is disclosed a low volatile, epoxidized plasticizer composition comprising a blend of a) one or more epoxidized fatty acid esters having at least 4% saturates; and b) one or more epoxidized bio-based oil, wherein the low volatile plasticizer is at least 80% free of organic volatiles. There is also disclosed a method of making a low volatile, epoxidized plasticizer composition as described herein, the method comprising hydrothermally treating the one or more epoxidized fatty acid esters and one or more epoxidized bio-based oil either before or after the blend is formed at conditions sufficient to remove at least 80% of trace organic volatiles while maintaining at least at least 4% saturates.

### FIELD OF THE INVENTION

The present disclosure generally relates to a low volatile, epoxidized plasticizer composition comprising a blend of one or more fatty acid esters having a sufficient level of saturates, and one or more bio-based oils, wherein the resulting plasticizer has a desirable low level of trace organic volatiles. The present disclosure also relates to methods of making the low volatile, epoxidized plasticizer, plasticized compositions comprising the epoxidized plasticizer compositions, as well as products made from such plasticized polymers.

### BACKGROUND OF THE INVENTION

One of the most commonly used polymers is polyvinyl chloride (PVC). The rigid properties and high chemical resistance associated with the unplasticized form of this vinyl halide polymer has led to its commercial success in a variety of applications, such as pipes and other plumbing supplies. However, there are many other applications that require PVC to be more flexible, which can be achieved by adding a plasticizer to the PVC. Plasticized PVC finds application in a variety of products, including, for example, films, sheeting, and wire and cable coverings.

In an attempt to solve the well-documented health and environmental concerns associated with the use of organics in PVC production, there has been a successful push for effective “green” plasticizers that do not contain organic volatiles. For example, the industry is turning to the use of alkyl ester of epoxidized vegetable oil as a “green” component in PVC formulation. These epoxide alkyl esters are produced by various epoxidation processes of bio diesel or by trans-esterification of epoxidized vegetable oils.

During the epoxidation of vegetable oils and their alkyl esters, however, trace amounts of various volatile hydrocarbons, ketones, aldehydes, peroxides, hydro peroxide and organic acids are known to form. These volatiles typically have less than 12 carbons in their structure, which can cause irritation to eyes and nose. Thus, there is a need for a process that efficiently removes these volatiles without adversely affecting the properties of the resulting PVC product.

To solve these problems, the Inventors have surprisingly discovered that undesirable organic volatiles can be reduced to a negligible or even a non-existent level by subjecting the starting materials to at least one hydrothermal treatment process. The Inventors have discovered a process that allows these organic volatiles to be successfully removed, while maintaining a sufficient level of saturates, such that the weight loss of the low volatile, epoxidized plasticizer composition is negligible.

### SUMMARY OF THE INVENTION

In one embodiment there is disclosed a low volatile, epoxidized plasticizer composition comprising a blend of a) one or more epoxidized fatty acid esters having at least 4% saturates; and b) one or more epoxidized bio-based oil, wherein the low volatile plasticizer is at least 80% free of organic volatiles.

In another embodiment, there is disclosed a method of making low volatile, epoxidized plasticizer composition comprising: providing one or more epoxidized fatty acid esters having at least 4% saturates, and one or more epoxidized bio-based oil; forming a blend of the one or more epoxidized fatty acid esters and the one or more epoxidized bio-based oils; hydrothermally treating the one or more epoxidized fatty acid esters and one or more epoxidized bio-based oil either before or after the blend is formed at conditions sufficient to remove at least 80% of trace organic volatiles while maintaining at least at least 4% saturates in the one or more epoxidized fatty acid esters. This method results in a weight loss of the epoxidized plasticizer composition of 2% or less.

In another embodiment, there is disclosed a plasticized polymer composition comprising one or more polymers and at least one low volatile, epoxidized plasticizer homogeneously dispersed within the polymer composition, wherein the plasticizer is at least 80% free of trace organic volatiles, and comprises a blend of a) one or more epoxidized fatty acid esters having at least 4% saturates; and b) one or more epoxidized bio-based oil.

In yet another embodiment, there is disclosed an article comprising: a plasticized polymer composition comprising a polyvinyl chloride polymer (PVC) chosen from PVC homopolymers, PVC copolymers, polyvinyl dichlorides (PVDC), and polymers of vinylchloride with vinyl, acrylic and other co-monomers; and at least one low volatile, epoxidized plasticizer homogeneously dispersed within the polymer composition, wherein the plasticizer is at least 80% free of trace organic volatiles, and comprises a blend of a) one or more epoxidized fatty acid esters having at least 4% saturates; and b) one or more epoxidized bio-based oil.

It is to be understood that both the foregoing general description and the following detailed description are exemplary and explanatory only and are not restrictive of the invention, as claimed.

### DETAILED DESCRIPTION OF THE INVENTION

Epoxidized vegetable oil typically contain 10-20% saturated alkyl esters. In soy bean oil methyl ester epoxide, saturated esters are methyl palmate and methyl stearate. It has been discovered that volatile compounds formed during epoxidation may stay with the epoxidized oil, which inherently cause problems from processing to the resulting product, even in trace amounts. These volatile compounds, which comprise mainly short chain compounds that contain less than about 12 carbons in their structure, such as aldehyde, ketone and hydrocarbons, and which are also naturally present in saturated fatty esters such as palmate and stearate, may cause unwanted properties in the final PVC product. For example, such compounds may seep from the film and leach if the film comes in contact with solvent or other oils. The migration of these saturated alkyl esters to the surface of PVC is not desired for a variety of reasons, including for example because it makes the surface of the film oily. In addition, these unwanted volatile compounds can cause health problems when PVC products containing these bio-plasticizers are being processed.

As a result of the foregoing problems, the Inventors have discovered a process that efficiently removes these volatiles that is based on a combination of water washing and steam stripping under a vacuum at a temperature above 130° C. In one embodiment, the Inventors developed a low volatile, epoxidized plasticizer composition comprising a blend of: a) one or more epoxidized fatty acid esters having at least 4% saturates; and b) one or more epoxidized bio-based oil, wherein the low volatile epoxidized plasticizer is at least 80% free of organic volatiles.

As used herein, the epoxidized fatty acid esters has at least 4 weight % saturates, preferably at least 6 weight % saturates, more preferably at least 8 weight % saturates, more preferably at least 10 weight % saturates, or even at least 20 weight % saturates, based on total weight percent as determined by standard gas chromatography analysis. In one embodiment, the saturate amounts range from 4 to 20 weight %, such as 4-10 weight % or 10-20 weight %, based on total weight percent as determined by standard gas chromatography analysis. These epoxidized fatty acid esters derived from one or more vegetable oils, and can include soy methyl ester, canola methyl ester, and/or other esters like ethyl ester, butyl ester, ethyl hexyl ester, octyl ester, or combinations thereof.

In various embodiments, the epoxidized fatty acid esters, which may be derived from a vegetable oil, comprises methyl ester derived from high linoleic soy bean oil, methyl ester derived from low saturated soy bean oil, methyl ester derived from high oleic canola oil, canola oil, sunflower oil, corn oil, high oleic algal oil, or combinations thereof.

The bio-based oils that can be used in the disclosed plasticizer composition, may comprise natural or genetically modified vegetable oils chosen from soybean oil, olive oil, peanut oil, cottonseed oil, linseed oil, sunflower oil, canola oil, sunflower oil, corn oil, high oleic algal oil, or combinations thereof.

As described, the Inventors have discovered a process that efficiently removes unwanted organic volatiles such that the resulting low volatile epoxidized plasticizer is at least 80% free of organic volatiles, such as at least 85% free of organic volatiles, at least 90% free of organic volatiles, at least 95% free of organic volatiles, or at least 98% free of organic volatiles, or at least 99% free of volatiles. In one embodiment, the resulting low volatile epoxidized plasticizer is at least 99.5, preferably at least 99.9% free of organic volatiles. Non-limiting examples of the organic volatiles include hydrocarbons, ketones, aldehydes, esters, hydroxy acetate, organic acids, such as formic acid, and acetic acid, hydro peroxide, organic peroxides, and the like.

The ratio between the fatty acid esters to the bio-based oils in the blend can range from 99:1 to 1:99, from 90:10 to 10:90, from 80:20 to 20:80, from 75:25 to 25:75, from 70:30 to 30:70, from 65:35 to 35:65, from 60:40 to 40:60, from 55:45 to 45:55, and from 50:50. In some embodiments, the ratio between the fatty acid ester to the bio-based oils can range from 100:0 to 0:100, i.e., (neat).

In one embodiment, the bio-based oil used in the disclosed plasticizer composition has an oxirane value of at least 3%, such as at least 6%, at least 7%, at least 8%, at least 9%, and at least 10%. In one embodiment, the bio-based oil has an oxirane value ranging from 3 to 10%/o. Further embodiments are directed to epoxidized soybean oils having an oxirane value ranging from 5 to 9%.

In addition to the disclosed epoxidized plasticizer composition, there is disclosed a method of obtaining the epoxidized plasticizer composition that effectively removes unwanted organic volatile compounds. In one embodiment, the method comprises providing one or more epoxidized fatty acid esters having at least 4% saturates, preferably at least 6 weight % saturates, more preferably at least 8 weight % saturates, more preferably at least 10 weight % saturates, or even at least 20 weight % saturates, based on total weight percent using standard gas chromotograph analysis, and one or more epoxidized bio-based oil, and forming a blend of these fatty acid esters and bio-based oils.

The fatty acid ester(s) and bio-based oil(s) can be blended together by means known in the art. The blending can occur at any time before the epoxidation reaction, but is generally done just prior to epoxidation, and in the reaction vessel in which epoxidation will occur. In one embodiment the two oils are metered into a reactor in the selected weight ratio, and admixed with heating to the reaction temperature of 60-80° C. to form a homogeneous admixture. Since the fatty acid ester(s) and bio-based oil(s) are blended before and during the epoxidation reaction, the resulting composition is well homogenized, even for reactants of different weights and viscosities.

The method further comprises hydrothermally treating the epoxidized fatty acid esters and the epoxidized bio-based oil either before or after the blend is formed at conditions sufficient to remove at least 80% of organic volatiles while maintaining at least 4% saturates in the one or more epoxidized fatty acid esters. The Inventors have discovered that the disclosed method beneficially results in a weight loss of epoxidized oils of 2% or less, such as less than 1%, less than 0.5%, or even less.

In one embodiment, the hydrothermally treating comprises at least one steam treating step that is performed at a temperature of at least 120° C., for a time of least 2 hours under vacuum, or at a temperature of at least 130° C., for a time of least 2 hours under vacuum. In another embodiment, steam treating is performed at a temperature ranging from 120 to 140° C., for a time ranging from 2 to 10 hours, or 4 to 10 hours, under vacuum of 0.5 mmHg or less.

The disclosed method may include at least one step of washing the fatty acid esters and/or the bio-based oils in water prior to hydrothermal treating.

Epoxidation of the homogeneous blend can occur by any method known in the art. In one embodiment, the desired ratio of one or more fatty acid esters and one or more bio-based oils are admixed to form a blend. Other additives, such as solvents, and additives to enhance the epoxidation reaction may be added to the blend prior to or during epoxidation. The blend is heated to the desired temperature for epoxidation (60-80° C.) and reactants are fed/added to the blend to carry out the epoxidation.

In one embodiment, a solvent such as toluene or xylene may optionally be added to the blend of fatty acid esters and bio-based oils to aid the quality of the final epoxide and to ease the processing. An organic acid such as formic, acetic or propionic acid may be added to the blend to aid in processing. An inorganic acid such as sulfuric acid may also be optionally added to the blend in order to increase the epoxidation rate. The blend is heated to the desired temperature and then H₂O₂ is slowly added to the blend. As this reaction is exothermic, it is controlled by cooling and by regulating the addition rate of H₂O₂. Measuring the iodine value of the oil can be used to monitor the progress of the reaction. For example, when the iodine value ranges from 1 to 3, the desired epoxidation level is typically achieved. At his point, the aqueous phase can be separated by gravity and the oil phase can be washed to remove any residue of hydrogen peroxide and acid. This oil phase can then be stripped under vacuum to remove the moisture, organic acid or any solvents.

In one embodiment, fatty acid ester such as methyl oleate is blended with bio-based vegetable oil, such as soybean oil, prior to epoxidation. In other embodiments, the blend contains fatty acid ester such methyl soyate and a bio-based vegetable oil such as soybean oil.

One advantage of the process described herein is that in the epoxidation of a blend containing soy methyl ester and vegetable oil, the soy methyl ester acts as a solvent for epoxidation of the vegetable oil. This reduces the need of a separate organic solvent, such as toluene, that must be used to reduce the viscosity of the vegetable oil as it is converted to the epoxide and permits subsequent phase separation and washing. The use of less organic solvent provides a variety of benefits including a safer, greener process (less organic solvent waste), and a product with less contamination. The elimination of the solvent also creates a more economical process requiring fewer steps, improving throughput, and reducing side reactions in separate epoxidation processes.

The epoxidized composition of the present disclosure may also be free of traces of alkaline metals (e.g., Na, Ca, and/or Mg ions), since the use of soy methyl ester in the blend enables one to wash the final epoxide with water, rather than the alkaline salts used to remove traces of acids in a commercial process. Additionally, the composition of the present disclosure can be free of hydroxyl acetate by-products, such as hydroxy acetate, found in blends of the separately epoxidized blend components.

In one embodiment, the fatty acid esters and the bio-based oil are unepoxidized prior to forming the blend. Thus, a single epoxidiation step is performed on the resulting blend. In another embodiment, the fatty acid esters and the bio-based oil are epoxidized prior to forming the blend. In this embodiment, the fatty acid esters and the bio-based oil are separately epoxidized and then mixed together to form a blend. This embodiment is useful when a commercially available, epoxidized biodiesel is used. In either embodiment, the epoxidation process(es) can be extended in order to achieve a desired ring opening structure for the epoxidized components. For example, the epoxidation process of soybean oil or a fatty acid methyl ester (FAME), or a blend of both, can be extended to open the ring to form hydroxyl alkyl. The formation of hydroxyl alkyl can be achieved by using an extended period of agitation during the epoxidation reaction, such as at least 3 hours, and in certain embodiments 6 to 12 hours. This will improve the resulting plasticizers compatibility with PVC, will reduce migration to the surface of the film and improve volatility. Alternatively, increasing the hydroxyl can be achieved directly by an epoxidation process of FAME or soybean oil and then a transesterification of the high hydroxyl soybean oil epoxide to its methyl ester epoxide.

There is also disclosed a plasticized polymer composition comprising one or more polymers and at least one plasticizer homogeneously dispersed within the polymer composition, wherein the plasticizer comprises the epoxidized plasticizer composition described herein. For example, in one embodiment, the plasticized polymer composition may comprise one or more polymers and at least one low volatile, epoxidized plasticizer homogeneously dispersed within the polymer composition, wherein the plasticizer is at least 80% free of organic volatiles, and comprises a blend of a) one or more epoxidized fatty acid esters having at least 4% saturates; and b) one or more epoxidized bio-based oil. A plasticized polymer composition described herein may include one or more polymers chosen from halogenated polymers, acid-functionalized polymers, anhydride-functionalized polymers, and nitrile rubbers.

In one embodiment, the plasticized polymer composition may be used to for a plasticized PVC article such as a PVC film. The Inventors have discovered that the volatility of a resulting plasticized PVC article may be less than 10% mass loss, such as less than 8% mass loss, based on ASTM D 1203-16. In one embodiment, the volatility of the resulting plasticized PVC article ranges from 4 to 7% mass loss.

In one embodiment, the polymer is a polyvinyl chloride polymer (PVC) chosen from PVC homopolymers, PVC copolymers, polyvinyl dichlorides (PVDC), and polymers of vinylchloride with vinyl, acrylic and other co-monomers. In another embodiment, the plasticized polymer composition described herein comprises one or more bio-polymers chosen from polylactic acid, polyhydroxy butyrate, polyamide 11 or mixtures thereof.

The plasticizer composition described herein may be present in the polymer composition in an amount up to 50 weight percent, based on the total amount of polymer, such as an amount ranging from 1 to 50 percent, from 1 to 40 percent, from 1 to 30 percent, from 1 to 25 percent, from 1 to 20 percent, from 5 to 30 percent, from 5 to 25, from 5 to 20 percent, 10 to 30 percent, from 10 to 25, and from 10 to 20 percent, all based on the weight of a polymer composition.

The plasticized polymer compositions described in the present disclosure can be formulated in a conventional manner, including various kinds of additives in addition to the epoxidized fatty acid esters of natural fats or oils. In various embodiments, the plasticized polymer composition may further comprise one or more adjuvants chosen from one or more fillers, pigments, flame retardants, dyes, stabilizers, UV stabilizers, lubricants, surfactants, flow aids, plasticizers or combinations thereof.

A non-limiting example of a typical flexible PVC formulation described herein comprises:
100 phr (part per hundred resin) of a high K value resin (vinyl resin);
30-100 phr of alkyl ester of epoxidized vegetable oil (loading of plasticizer depends on flexibility required for variety of applications);
0-50 phr of epoxidized Soybean Oil (co-stabilizer and plasticizer); and
1-5 phr of Heat Stabilizer, such as a barium/zinc stabilizer or other suitable stabilizer.

Bioplasticizers described herein are in the form of epoxidized alkyl fatty esters and can be manufactured by two methods. One method is the trans-esterification of epoxidized vegetable oil, such as epoxidized soybean oil (Vikoflex™ 7170), with the desired alcohol, such as methanol, ethanol, propanol, butanol or any other alcohols using a base catalyst. The second method is the direct epoxidation of alkyl ester fatty acids such as soy methyl ester, which is also known as a biodiesel. As described in more detail below, both processes have been shown to eliminate at least 80%, 98% and more than 99% of amounts of volatile organics, such as hydrocarbons, ketones, aldehydes and others volatiles are formed during the epoxidation of vegetable oils or their alkyl esters. Non-limiting examples of properties for different plasticizers described herein are shown in the Examples and Tables that follow.

### Examples

### Procedure Used to Make Plasticizers:

Bioplasticizers described herein were in the form of epoxidized alkyl fatty esters and were manufactured by two methods. The first method used was the trans-esterification of epoxidized vegetable oil, specifically epoxidized soybean oil (Vikoflex™ 7170) or epoxidized canola oil. The second method used was the direct epoxidation of alkyl ester fatty acids, specifically soy fatty acid methyl ester (FAME).

Each of these oils were treated using the hydrothermal treatment step described herein, and compared to identical samples that did not undergo the hydrothermal treatment step. In a one liter three neck flask equipped with an agitator and thermometer, there was added 500 grams of oil from an epoxidation reaction of alkyl esters or oil phase from trans-esterification of epoxidized vegetable oil. This oil was washed three times with an equal amount of water. This oil was then hydrothermally treated, which comprised steam stripping at a temperature of at least 130° C. for four hours under a full vacuum (0.5 mmHg or lower). After this step, the steam was turned off and the contents of the reactor were dried at 110° C. for another hour under full vacuum. Gas Chromatography (GC) and Gas Chromatography/Mass Spectrometry (GC/MS) were used to measure the amounts of organic volatiles on each sample using the following methods.

### Gas Chromatography:

GC of the resulting sample was then compared to the GC of a sample that did not undergo the same hydrothermal treatment step. In particular, the inventive example that was subjected to a steam stripping step of 130° C. for 4 hours was compared to a sample oil that was steamed at a lower temperature and time (110° C. for 1 hour). The process comprising the lower steam temperature and time is a treatment used in the industry after peroxidation to remove volatile. As shown in Table 1, the disclosed hydrothermal treatment step (130° C.) leads to the removal of most of the organic volatiles, as evident by the head space GC of these oils, which indicates that the treated according to the present disclosure emitted less organic volatile than the comparative sample.

TABLE 1

| | Area of volatile compounds | | |
|---|---|---|---|
| | before methyl palmitate Peak | | |
| | Not Washed | Washed and | |
| Epoxidation Process | or Stripped | Stripped | % Removal |
| Trans-esterification | 313804 | 1601 | 99.5 |
| FAME Epoxidation | 1191860 | 18947 | 98.4 |

According to GC/MS analysis, the volatile compounds described in Table 1 are shown to be volatiles having less than 16 carbon in their structure. Non-limiting examples of such volatile compounds include hydrocarbons, ketones, aldehydes, organic peroxide, acids and others. A more detail list of these compounds is provided in Table 2.

GC testing of the above samples was performed in the following manner. 2.5 grams of oil were placed in 30 ml vial and then this vial was sealed and placed in a convection oven at 130° C. for 10 minutes. Immediately after taking the vial out of the oven, 2.5 ml of the head space above the oil was drawn by a syringe with an opening/closing valve and then injected into the GC system with the following conditions:
Column: DB-1 mega bore 30 m×0.53 mm, 1.5 micron film thickness.
Program conditions: initial temperature 50° C., 2 minute hold, ramp 15° C./minute to 250° C. Hold 5 minutes.
Injector Temperature: 260° C.
Detector Temperature: 280° C.
Carrier gas: hydrogen, Column flow: 75 ml/min.

Gas Chromatography/Mass Spectrometry:

GC/MS testing of the above samples in Table 1 was performed in the following manner. Approximately 2-2.5 g of oil were weighed out into a 22 mL headspace vial and heated at 130° C. for 10 min. One injection was taken using a Tekmar HT3 headspace autosampler and compared to a blank. Compound identifications were made by comparison to a NIST spectral library.

As shown in Table 2, samples that underwent hydrothermal treatment step showed less material in the chromatogram due to the removal of most of the organic volatiles which confirmed the GC testing.

| | | FAME | FAME | Trans- | Trans- |
|---|---|---|---|---|---|
| | | epoxidation | epoxidation | esterification | esterification |
| | | process | process | process | process |
| | | Not washed or | Washed and | Not washed or | Washed and |
| Description | | stripped | stripped | stripped | stripped |
| Components | Pentane | 17.67 | 25.20 | 67.26 | 47.25 |
| (% area) | Propanal | 35.64 | 38.18 | 7.00 | 19.37 |
| | Hexane | 0.54 | 1.36 | ND | 0.74 |
| | Acetic acid | 2.01 | ND | ND | ND |
| | Butanal | 0.78 | 0.87 | ND | 1.00 |
| | 2-butanone | 0.28 | 0.32 | ND | ND |
| | 1-heptane | 0.25 | ND | ND | ND |
| | Propanoic acid | 2.83 | 1.41 | ND | ND |
| | 2-ethyl furan | 0.21 | 0.30 | ND | ND |
| | Pentanal | 1.54 | 1.81 | 0.41 | 1.76 |
| | Octene | 1.82 | 0.85 | ND | ND |
| | Hexanal | 16.46 | 12.04 | 2.09 | 5.51 |
| | 2-heptanone | 0.20 | 0.16 | ND | ND |
| | Heptanal | 0.61 | 0.20 | ND | ND |
| | Hexanoic acid | 0.73 | 0.22 | ND | ND |
| | Cis-2-heptene | 0.86 | 0.80 | ND | ND |
| | 2-pentyl furan | 0.57 | 0.59 | ND | ND |
| | Octanal | 0.24 | 0.20 | ND | ND |
| | Methyl | 0.25 | 0.12 | ND | ND |
| | heptanoate | | | | |
| | Nonal | 2.49 | 0.51 | ND | ND |
| | Methyl octanoate | 6.18 | 1.68 | ND | ND |
| | Methyl | 0.46 | 0.08 | ND | ND |
| | nonanoate | | | | |
| | Methyl 8- | 0.37 | 0.24 | ND | 5.09 |
| | oxooactanoate | | | | |
| | Methyl 9- | 2.93 | 1.75 | ND | ND |
| | oxononanoate | | | | |
| | Methyl | ND | 0.80 | 3.26 | 1.71 |
| | tetradecanoate | | | | |
| | Methyl | 4.10 | 10.29 | 19.99 | 17.58 |
| | hexadecanoate | | | | |
| | Total | 100.00 | 100.00 | 100.00 | 100.00 |

GC/MS analysis conditions used in the measurements above are as follows:
Column: Restek Rtx-502.2 30 m×250 μm×1.4 μm film thickness.
GC: Agilent 6890
Detector: Agilent 5973 MSD
Ionization: E1
MSD Line Temp: 280° C.
Source Temp: 230° C.
Scan Range: 15 m/z-500 m/z
Inlet Temp: 260° C.
Constant Flow: 1.5 mL/min
Carrier Gas: He
Split: 10:1
Column: Restek Rtx-502.2 30 m×250 μm×1.4 μm film thickness.
Program conditions: initial temperature 50° C., 4 minute hold, ramp 5° C./minute to 270° C.

The epoxidized alkyl fatty acid ester epoxide plasticizer from vegetable oil free of traces of organic volatiles was added as a plasticizer in the following plastisol formulation:
100 phr PVC homopolymer dispersion resin.
40-70 phr alkyl fatty acid ester epoxide plasticizer free of traces of organic volatiles.
0-5 phr Epoxidized Soybean Oil.
0-3 phr Barium Zinc heat stabilizer

In one embodiment, flexible PVC products were made from the above formulation using a multi-step process, which included the following. Samples of flexible PVC vinyl compounds were prepared as follows: 40-70 phr of the epoxidized alkyl fatty acid ester epoxide plasticizer free of traces of organic volatiles was added in a Hobart mixer. 100 phr of the PVC resin was added slowly, mixing for few minutes, followed by the addition of 0-5 phr epoxidized Soybean Oil and 0-3 phr Barium Zinc heat stabilizer into the mixture.

Four different plasticizer were produced from the above formulations, and these plasticizers were then used make flexible PVC products using the following multi-step process. A pre-mixture of the PVC formulation was mixed before being converted to the final product by heating briefly to the fusion temperature and then cooling. In particular, plasticized PVC sheets were made using a hot press (190° C., 10 min) followed by a cold press. The resulting product that was used for testing was a fused, 80 mils thick sample. The following properties were measured on the test sample to evaluate the useful of the material: hardness, modulus of flexibility, low temperature flexibility and volatility. See Table 3.

TABLE 3
FLEXIBLE PVC APPLICATIONS

| | | | | | Volatility | Volatility |
|---|---|---|---|---|---|---|
| | | | | | 24 hrs | 24 hrs |
| | Mechanical properties | | | | 100° C. | 100° C. |
| | | Tensile | | Brittleness | w/out | w/ |
| | Hardness | strength | 100% | Temp | charcoal | charcoal |
| Sample | shore A | (psi) | Modulus | (C.) | Weight loss % | |
| Plasticized PVC | 76 | 2598 | 1202 | −36 | −4.3 | −7.1 |
| film 1 | | | | | | |
| Soy FAME | | | | | | |
| epoxidation | | | | | | |
| process | | | | | | |
| Not washed or | | | | | | |
| stripped | | | | | | |
| Plasticized PVC | 75 | 2589 | 1123 | −37 | −3.9 | −6.7 |
| film 2 | | | | | | |
| Soy FAME | | | | | | |
| epoxidation | | | | | | |
| process | | | | | | |
| Washed and | | | | | | |
| stripped | | | | | | |
| Plasticized PVC | 75 | 2762 | 1132 | −36 | −4.1% | −7.1 |
| film 3 | | | | | | |
| Tranesterification | | | | | | |
| process of | | | | | | |
| epoxdized soybean | | | | | | |
| oil | | | | | | |
| Not washed or | | | | | | |
| stripped | | | | | | |
| Plasticized PVC | 75 | 2527 | 1149 | −37 | −3.8% | −6.7 |
| film 4 | | | | | | |
| Transesterification | | | | | | |
| process of | | | | | | |
| epoxidized soybean | | | | | | |
| oil | | | | | | |
| Washed and | | | | | | |
| stripped | | | | | | |
| Plasticized PVC | 80 | 3170 | 343 | | −3.2% | −6.7% |
| film 5 | | | | | | |
| Transesterification | | | | | | |
| process of | | | | | | |
| epoxidized canola | | | | | | |
| oil | | | | | | |
| Washed and | | | | | | |
| Stripped | | | | | | |

As evident from the Table 3, all samples show similar mechanical properties. However the samples that underwent hydrothermal treatment step (Plasticized PVC film 2 and Plasticized PVC film 4, Plasticized PVC film 5) show an improvement on volatility probably due to the removal of organic volatiles.

Similar low volatile plasticizers can be obtained from other vegetable oils, animal fat and their alkyl esters using the procedure described in this disclosure. Other plasticizers that are made by direct esterification of any fatty acid or a combination of fatty acids that are esterified with any alcohol and then converted by an epoxidation procedure to an epoxy and finally washed and steam stripped under vacuum at high temperature to remove volatiles. The weight loss values shown in Table 3 describes the volatility of plasticized PVC film applications, not of the epoxidized oils.

1. A low volatile, epoxidized plasticizer composition comprising a blend of:
a) one or more epoxidized fatty acid esters having at least 4% saturates; and
b) one or more epoxidized bio-based oil,
wherein the low volatile epoxidized plasticizer is at least 80% free of organic volatiles.

2. The composition of claim 1, wherein the epoxidized fatty acid esters are derived from one or more vegetable oils.

3. The composition of claim 2, wherein the epoxidized fatty acid esters comprise epoxidized soy methyl ester, epoxidized canola methyl ester, or combinations thereof.

4. The composition of claim 2, wherein said epoxidized fatty esters is one or more alkyl esters.

5. The composition of claim 2, wherein the fatty acid esters comprise methyl ester derived from high linoleic soy bean oil, methyl ester derived from low saturated soy bean oil, methyl ester derived from high oleic canola oil, sunflower oil, corn oil, high oleic algal oil, or combinations thereof.

6. The composition of claim 1, wherein the epoxidized bio-based oils comprise natural or genetically modified epoxidized vegetable oils chosen from soybean oil, olive oil, peanut oil, cottonseed oil, linseed oil, sunflower oil, canola oil, sunflower oil, corn oil, high oleic algal oil, or combinations thereof.

7. The composition of claim 1, wherein the one or more fatty acid esters have at least 5% saturates.

8. The composition of claim 1, wherein the low volatile plasticizer is at least 95% free of organic volatiles.

9. The composition of claim 1, wherein the low volatile plasticizer is at least 99% free of organic volatiles.

10. The composition of claim 1, wherein the blend comprises epoxidized fatty acid esters and epoxidized bio-based oils in a weight ratio ranging from 90:10 to 10:90.

11. The composition of claim 1, wherein the organic volatiles are chosen from hydrocarbons, ketones, aldehydes, esters, hydroxy acetate, organic acids, hydro peroxide, and organic peroxide that are eluted prior to methyl palmatate peak according to GCMS method.

12. The composition of claim 1, wherein the composition is free of alkaline metals chosen from sodium, calcium and magnesium ions.

13. The composition of claim 1, wherein the fatty acid esters and the bio-based oil are unepoxidized prior to forming the blend.

14. The composition of claim 1, wherein the fatty acid esters and the bio-based oil are epoxidized prior to forming the blend.

15. A method of making low volatile, epoxidized plasticizer composition comprising:
providing one or more epoxidized fatty acid esters having at least 4% saturates, and one or more epoxidized bio-based oil;
forming a blend of the one or more epoxidized fatty acid esters and the one or more epoxidized bio-based oils;
hydrothermally treating the one or more epoxidized fatty acid esters and one or more epoxidized bio-based oil either before or after the blend is formed at conditions sufficient to remove at least 80% of organic volatiles while maintaining at least 4% saturates in the one or more epoxidized fatty acid esters, wherein the method results in a weight loss of epoxidized oils of 2% or less.

16. The method of claim 15, wherein the one or more fatty acid esters and the bio-based oils are epoxidized either prior to forming the blend or in a single epoxidation step after the blend is formed.

17. The method of claim 15, wherein hydrothermally treating comprises at least one steam treating step that is performed at a temperature of at least 120° C., for a time of least 2 hours while under vacuum.

18. The method of claim 15, wherein hydrothermally treating comprises at least one steam treating step that is performed at a temperature of at least 130° C., for a time of least 2 hours while under vacuum.

19. The method of claim 15, wherein hydrothermally treating comprises at least one steam treating step that is performed at a temperature ranging from 120 to 140° C., for a time ranging from 2 to 10 hours under vacuum of 0.5 mmHg or less.

20. The method of claim 15, further comprising at least one step of washing the fatty acid esters and/or the bio-based oils in water prior to hydrothermal treating.

21. The method of claim 15, wherein said method results in a weight loss of the epoxidized oils of 0.5% or less.

22. The method of claim 15, wherein the epoxidized fatty acid esters having at least 6% saturates and are derived from one or more vegetable oils.

23. The method of claim 22, wherein the epoxidized fatty acid esters comprise methyl ester derived from high linoleic soy bean oil, methyl ester derived from low saturated soy bean oil, high oleic methyl ester canola oil, high oleic soy bean oil, high oleic algal oil, sunflower oil, corn oil, canola oil or combinations thereof.

24. The method of claim 21, wherein the epoxidized fatty acid esters comprise soy methyl ester, canola methyl ester, or combinations thereof.

25. The method of claim 21, wherein the epoxidized fatty acid esters are at least one or more alkyl esters.

26. A plasticized polymer composition comprising one or more polymers and at least one low volatile, epoxidized plasticizer homogeneously dispersed within the polymer composition, wherein the plasticizer is at least 80% free of organic volatiles, and comprises a blend of:
a) one or more epoxidized fatty acid esters having at least 4% saturates; and
b) one or more epoxidized bio-based oil.

27. The plasticized polymer composition of claim 26, wherein the polymers comprise one or more polymers chosen from halogenated polymers, acid-functionalized polymers, anhydride-functionalized polymers, and nitrile rubbers.

28. The plasticized polymer composition of claim 26, wherein the polymer is a polyvinyl chloride polymer (PVC) chosen from PVC homopolymers, PVC copolymers, polyvinyl dichlorides (PVDC), and polymers of vinylchloride with vinyl, acrylic and other co-monomers.

29. The plasticized polymer composition of claim 26, wherein the polymers comprise one or more bio-polymers chosen from polylactic acid, polyhydroxy butyrate, polyamide 11 and mixtures thereof.

30. The plasticized polymer composition of claim 26, wherein the plasticizer is present in the polymer composition in an amount of from 1 weight percent to 50 weight percent, based on the total amount of polymer.

31. The plasticized polymer composition of claim 26, further comprising one or more adjuvants chosen from one or more fillers, pigments, flame retardants, dyes, stabilizers, UV stabilizers, lubricants, surfactants, flow aids, plasticizers or combinations thereof.

32. An article comprising:
a plasticized polymer composition comprising a polyvinyl chloride polymer (PVC) chosen from PVC homopolymers, PVC copolymers, polyvinyl dichlorides (PVDC), and polymers of vinylchloride with vinyl, acrylic and other co-monomers; and
at least one low volatile, epoxidized plasticizer homogeneously dispersed within the polymer composition, wherein the plasticizer is at least 80% free of organic volatiles, and comprises a blend of:
a) one or more epoxidized fatty acid esters having at least 4% saturates; and
b) one or more epoxidized bio-based oil.
